(19) United States
(12) Patent Application Publication
(10) Pub. No.: US 2013/0320660 A1
(43) Pub. Date: Dec. 5, 2013

(54) FLYER ASSEMBLY AND RELATED METHODS

(71) Applicant: AVERY DENNISON CORPORATION, Pasadena, CA (US)

(72) Inventors: Jay K. Sato, Mission Viejo, CA (US); Melissa Gruber, Santa Ana, CA (US); Mark Abramowitz, Yorba Linda, CA (US); Susanna L. Schroeder, Laguna Niguel, CA (US)

(21) Appl. No.: 13/910,074

(22) Filed: Jun. 4, 2013

Related U.S. Application Data
(60) Provisional application No. 61/655,468, filed on Jun. 4, 2012.

(51) Int. Cl. B42D 15/00

(52) U.S. Cl. CPC B42D 15/00
USPC 283/56; 156/252; 156/249

(57) ABSTRACT

An apparatus of the present invention includes a pad sheet having at least one coupon; and at least one anchor strip coupled to the at least one coupon. The pad sheet further includes a base sheet from which the at least one coupon and the at least one anchor strip is formed, and a microperforation line and a perforation line between which the anchor strip is located. The apparatus is further configured to be fed through a printer. A method of assembling a flyer assembly according to the present invention includes providing a base sheet material, forming at least one perforation line in the base sheet material, forming at least one microperforation line in the base sheet material parallel to the at least one perforation line, and attaching an adhesive strip to the base sheet material between the perforation line and the microperforation line.

### CROSS-REFERENCE TO RELATED APPLICATION

This application is based upon and claims priority to U.S. Provisional Application No. 61/655,468, filed on Jun. 4, 2012, entitled “Flyer Assembly and Related Methods” by Jay K. Sato, Melissa Gruber, Mark Abramowitz, and Susanna L. Schroeder, the entire contents of which are fully incorporated herein by reference.

### FIELD OF THE INVENTION

The present invention relates generally to a flyer assembly, and more specifically to a flyer assembly having removable coupons.

### BACKGROUND

Existing flyers, especially do-it-yourself flyers, have a relatively small number of detachments/coupons, which typically are cut out along one edge of the flyer. A small business owner posting such a flyer would have to return to the place where the flyer is posted, and replace the flyer after all of the coupons are removed. Also, in most cases, the top edge of the coupon is torn from the remaining portion of the flyer, and, as a result, the coupon can be damaged during the removal process.

### SUMMARY

In accordance with one embodiment of the present invention, a pad sheet includes at least one coupon; and at least one anchor strip coupled to the at least one coupon.

In other, more detailed features of the invention, the pad sheet further includes a base sheet from which the at least one coupon and the at least one anchor strip are formed. The base sheet can be made of a material selected from the group consisting of cardstock sheet, printable papers, printable films, non-woven materials, polyolefin materials, and laminates thereof.

In other, more detailed features of the invention, the pad sheet has a size selected from the group consisting of A3, A4, 8½ inches by 11 inches, 8½ inches by 14 inches, 11 inches by 17 inches, and other sizes that can be printed using a desktop printer and/or copier.

In other, more detailed features of the invention, the pad sheet further includes a microperforation line and a perforation line. In this embodiment, the at least one anchor strip is between the microperforation line and the perforation line.

In other, more detailed features of the invention, the at least one coupon includes two or more coupons, each of the two or more coupons is coupled to another of the two or more coupons, and each of the two or more coupons is coupled to the at least one anchor strip. In some embodiments, a line of separation is between each of the two or more coupons.

In other, more detailed features of the invention, the pad sheet includes at least one row of coupons, and the row of coupons includes the at least one coupon and the at least one anchor strip.

In other, more detailed features of the invention, the pad sheet further includes an adhesive that is coupled to the anchor strip. In some embodiments, the adhesive is selected from the group consisting of a removable adhesive, a permanent adhesive, a repositionable adhesive, and an ultraremovable adhesive. In some embodiments, the pad sheet further includes a liner that is coupled to the adhesive such that the adhesive is coupled between the anchor strip and the liner.

In other, more detailed features of the invention, the pad sheet is configured to be fed through a desktop printer.

In other, more detailed features of the invention, the pad sheet further includes a flyer sheet, and the pad sheet is configured to be coupled to the flyer sheet. In some embodiments, the flyer sheet is made of a material selected from the group consisting of cardstock sheet, printable papers, printable films, non-woven materials, polyolefin materials, and laminates thereof. In some embodiments, the flyer sheet has a size selected from the group consisting of A3, A4, 8½ inches by 11 inches, 8½ inches by 14 inches, 11 inches by 17 inches, and other sizes that can be printed using a desktop printer and/or copier. The flyer sheet is configured such that it may be fed through a printer.

In accordance with another exemplary embodiment, a method of manufacturing a pad sheet includes providing a base sheet material, and forming at least one perforation line in the base sheet material. The method further includes the tasks of forming at least one microperforation line in the base sheet material parallel to the at least one perforation line, and attaching an adhesive strip to the base sheet material between the at least one perforation line and the at least one microperforation line.

In accordance with another embodiment of the present invention, the step of forming the at least one perforation line of the method of manufacturing the pad sheet includes forming more than one perforation line; and the step of forming the at least one microperforation line includes forming more than one microperforation line.

In accordance with another embodiment of the present invention, a method of assembling a flyer assembly includes providing a pad sheet that includes rows of coupons; separating a first row of coupons from the remaining portion of the pad sheet; providing a flyer sheet; and coupling the first row of coupons to the flyer sheet.

In other, more detailed features of the invention, the first row of coupons of the method of assembling the flyer assembly includes an anchor strip; and the step of coupling the first row of coupons to the flyer sheet includes coupling the anchor strip to the flyer sheet.

In other, more detailed features of the invention, the method of assembling the flyer assembly further includes separating a second row of coupons from the remaining portion of the pad sheet; and coupling the second row of coupons to the first row of coupons. In other embodiments, the second row of coupons includes an anchor strip; and the step of coupling the second row of coupons to the first row of coupons includes coupling the anchor strip of the second row to the anchor strip of the first row.

Numerous advantages and benefits of the inventive subject matter disclosed herein will become apparent to those of ordinary skill in the art upon reading and understanding the present specification.

### BRIEF DESCRIPTION OF THE DRAWINGS

The inventive subject matter disclosed herein can take form in various components and arrangements of components, and in various steps and arrangements of steps. The drawings are only for purposes of illustrating preferred embodiments and are not to be construed as limiting. Further, it is to be appreciated that the drawings are not necessarily to scale. Features, aspects and advantages of the present invention will become better understood with reference to the following description and accompanying drawings, where:

FIG. 1 is a front elevational image of an embodiment of a flyer assembly according to the present invention, the flyer assembly including a flyer sheet and at least two rows of coupons that are coupled to the flyer sheet with a user manually removing one of the coupons and exposing another coupon that underlies the coupon that is being removed.

FIG. 2 is a front elevational image of the flyer assembly of FIG. 1 coupled to a bulletin board.

FIG. 3 is a front elevational illustration of an embodiment of a flyer sheet according to the present invention.

FIG. 4 is a top plan illustration of an embodiment of a flyer sheet having a coating according to the present invention.

FIG. 5 is a side elevational illustration of the flyer sheet of FIG. 4.

FIG. 6 is a top plan illustration of the flyer sheet of FIG. 3.

FIG. 7 is a side elevational illustration of the flyer sheet of FIG. 3.

FIG. 8 is a flow diagram of an example method of manufacturing an embodiment of a flyer sheet according to the present invention.

FIG. 9 is a front elevational illustration of an embodiment of a pad sheet according to the present invention.

FIG. 10 is a back elevational illustration of the pad sheet of FIG. 9.

FIG. 11 is a side elevational illustration of the pad sheet of FIG. 9.

FIG. 12 is a back elevational illustration of another embodiment of a pad sheet according to the present invention.

FIG. 13 is another back elevational illustration of the pad sheet of FIG. 12.

FIG. 14 is a top plan illustration of the pad sheet of FIG. 9.

FIG. 15 is a bottom plan illustration of the pad sheet of FIG. 9.

FIG. 16 is a side elevational illustration of an embodiment of a pad sheet having a coating according to the present invention.

FIG. 17 is a top plan illustration of the pad sheet of FIG. 16.

FIG. 18 is a bottom plan illustration of the pad sheet of FIG. 16.

FIG. 19 is a flow diagram of an example method of manufacturing an embodiment of a pad sheet according to the present invention.

FIG. 20 is a schematic illustration of the example equipment and example manufacturing steps that are associated with the flow diagram of FIG. 19.

FIG. 21 is a partial side elevational illustration of the pad sheet of FIG. 9.

FIG. 22 is a side elevational illustration of another embodiment of a pad sheet according to the present invention.

FIG. 23 is a flow diagram of an example method of collating and packaging an embodiment of a flyer assembly according to the present invention.

FIG. 24 is a flow diagram of an example method of assembling an embodiment of a flyer assembly according to the present invention.

FIG. 25 includes a first front perspective illustration of a row of coupons being applied on top of another row of coupons that are coupled to a flyer sheet, and a second front elevational illustration showing a user manually removing one of the coupons from a flyer assembly.

FIG. 26 is a side elevational illustration of another embodiment of a flyer assembly including two rows of coupons coupled to a flyer sheet.

FIG. 27 is a top plan illustration of the flyer assembly of FIG. 26.

FIG. 28 is a bottom plan illustration of the flyer assembly of FIG. 26.

FIG. 29 is a side elevational illustration of another embodiment of a flyer assembly including two rows of coupons coupled to a flyer sheet.

FIG. 30 is a front elevational illustration of another embodiment of a pad sheet according to the present invention.

FIG. 31 is a flow diagram of an example method of using the flyer assembly according to an embodiment of the present invention.

FIG. 32 is a perspective view of a printer showing a stack of the pad sheets of the present invention in an input tray of the printer and in an output tray of the printer after the indicia have been printed on the coupon portions of the pad sheet.

### DETAILED DESCRIPTION

The present invention is embodied in a flyer assembly and related methods. Flyer assemblies come in a multitude of configurations. It will be appreciated that modifications to disclosed and described examples, arrangements, configurations, components, elements, apparatuses, methods, materials, etc., can be made and may be desired for a specific application. In this disclosure, any identification of specific shapes, materials, techniques, arrangements, thicknesses, etc., are either related to a specific example presented or are merely a general description of such a shape, material, technique, arrangement, thickness, etc. Identification of specific details or examples are not intended to be, and should not be, construed as mandatory or limiting unless specifically designated as such. A few non-limiting examples of flyer assemblies are discussed below.

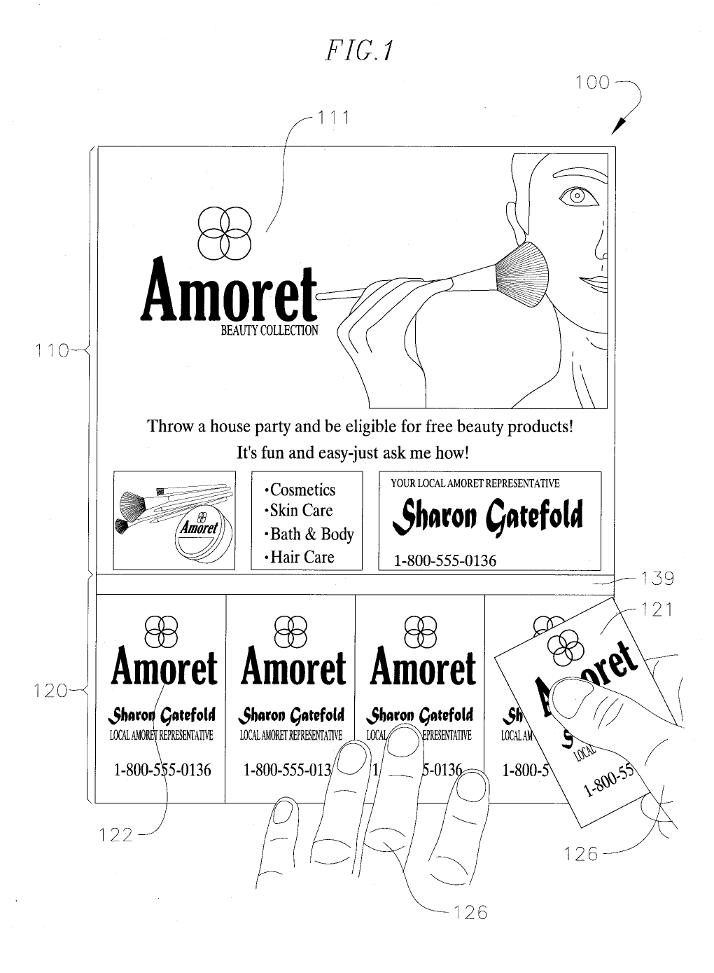

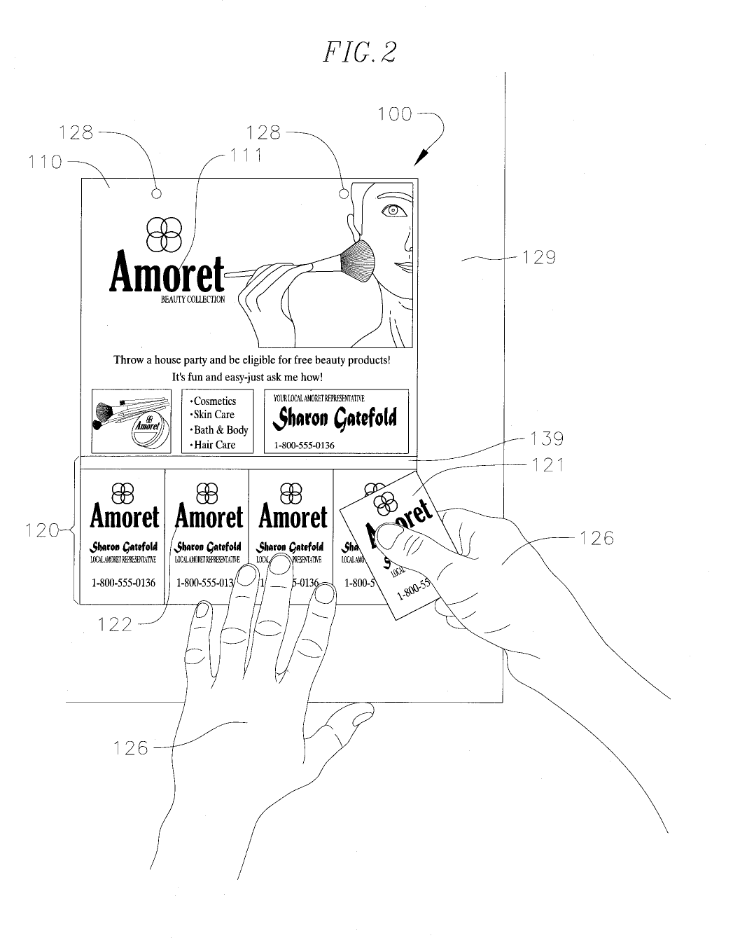

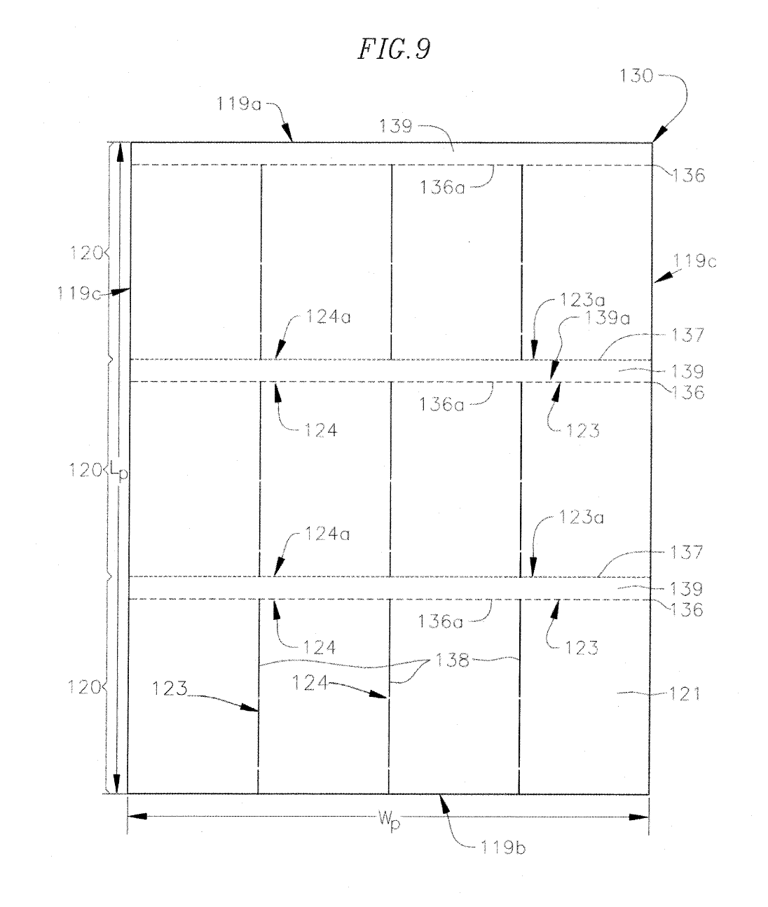

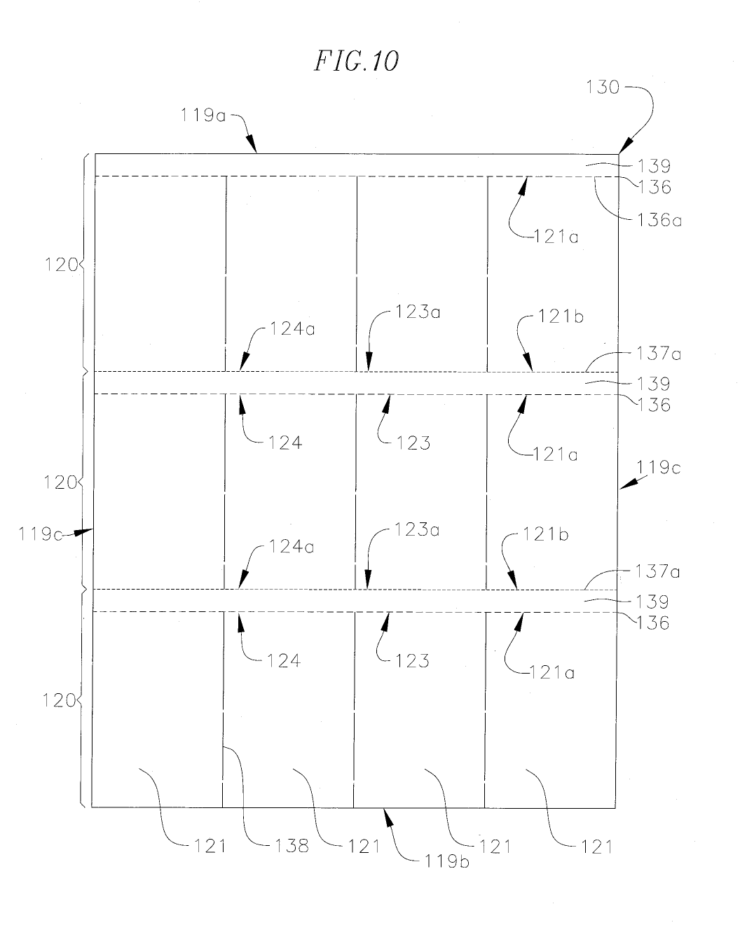

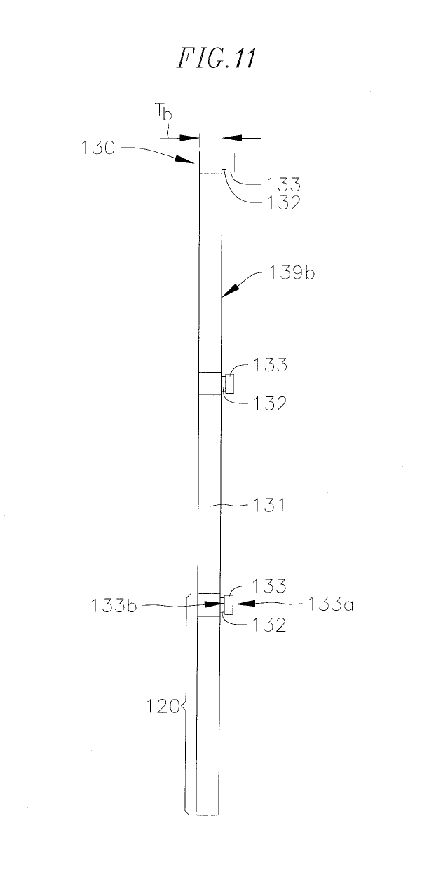

As shown in FIG. 1, an embodiment of a flyer assembly 100 according to the present invention includes two components: (1) a flyer sheet 110, and (2) one or more coupon rows 120, where the coupon rows 120 are formed from a pad sheet 130, as shown in FIG. 9. As shown, the coupon rows 120 are stacked one on top of the other. Alternative embodiments can have the coupon rows 120 offset from one another, either in a staggered or shingled configuration. Thus, the flyer assembly 100 is assembled from a flyer sheet 110 and portions of a pad sheet 130 (as shown in FIG. 9), and, in some embodiments, the flyer sheet(s) 110 and pad sheet(s) 130 (as shown in FIG. 9) are sold together as a single product. While the flyer assembly 100 is shown in FIGS. 1 and 2 coupled to a bulletin board 129 (also referred to as a cork board) with push pins 128, for example, the flyer assembly 100 can be coupled to a multitude of surfaces with various coupling devices/methods, for example, tape, staples, thumb tacks, and glue. FIGS. 1 and 2 show a user 126 removing one of the coupons 121 from a row of coupons 120.

As shown in FIGS. 1 and 2, the flyer sheet 110 can include a variety of printed information (also referred to as printed indicia) 111, for example, advertising copy related to a product, such as in this example embodiment, e.g., “Amoret Beauty Collection.” The indicia 111 can also include product images, product categories, and the name and telephone number of a sales representative, e.g., “Sharon Gatefold.” Also, each of the coupons 121 in this example embodiment are shown being printed with information 122. As illustrated in greater detail here, for example, the coupons 121 each include the “Amoret” logo, the representative name “Sharon Gatefold,” and the phone number “1-800-555-0136” from the advertising copy or indicia 111 on the flyer sheet 110. Accordingly, the flyer assembly 100 can include the same or similar information/indicia 111, 122 that is printed on both the flyer sheet 110 and the coupons 121. It should be understood that the term “coupon” includes, for example, coupons, business cards, tickets, maps, and other information carrying cards or sheets. Additionally, a coupon 121 can include, for example, a sheet of labels, a sheet of sticky notes, a sheet that includes hook and loop components, or other components that can adhere the coupon to another surface.

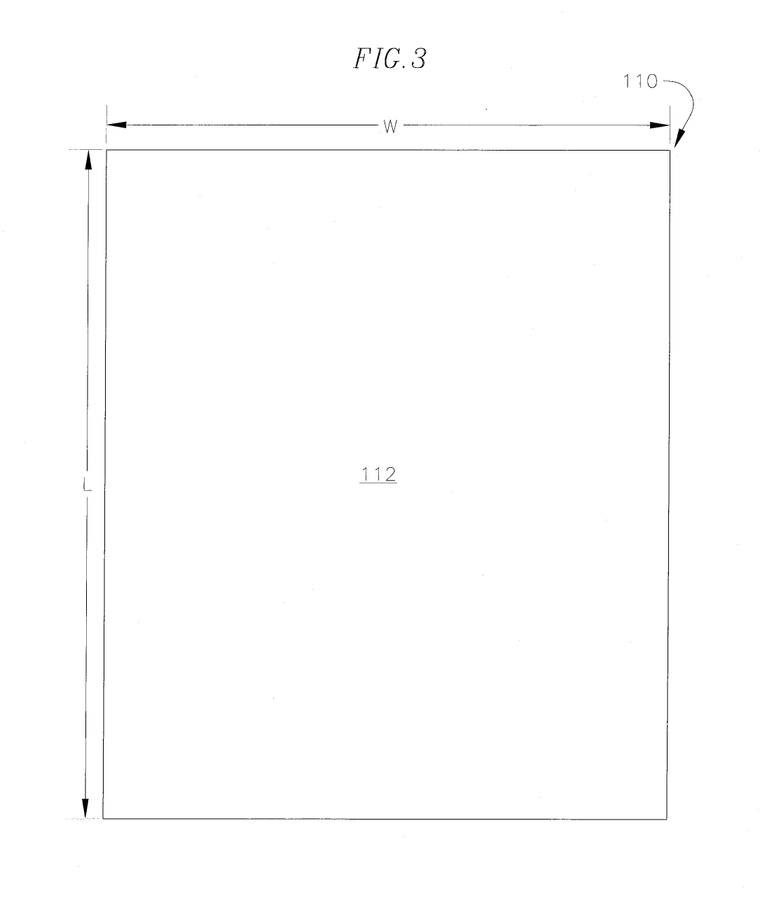

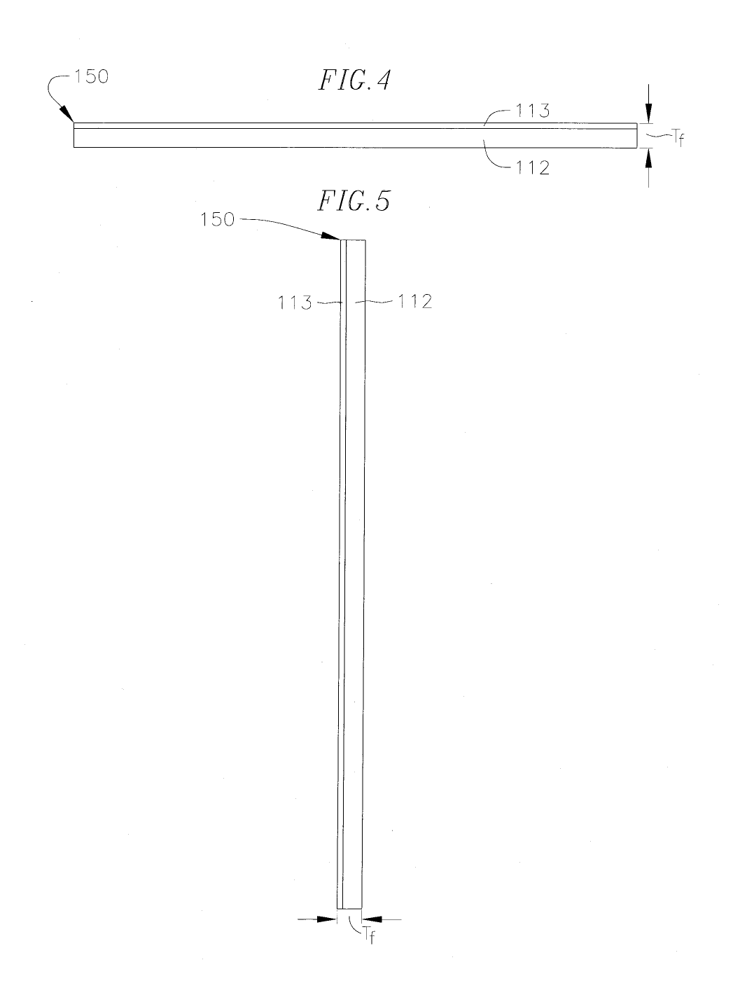

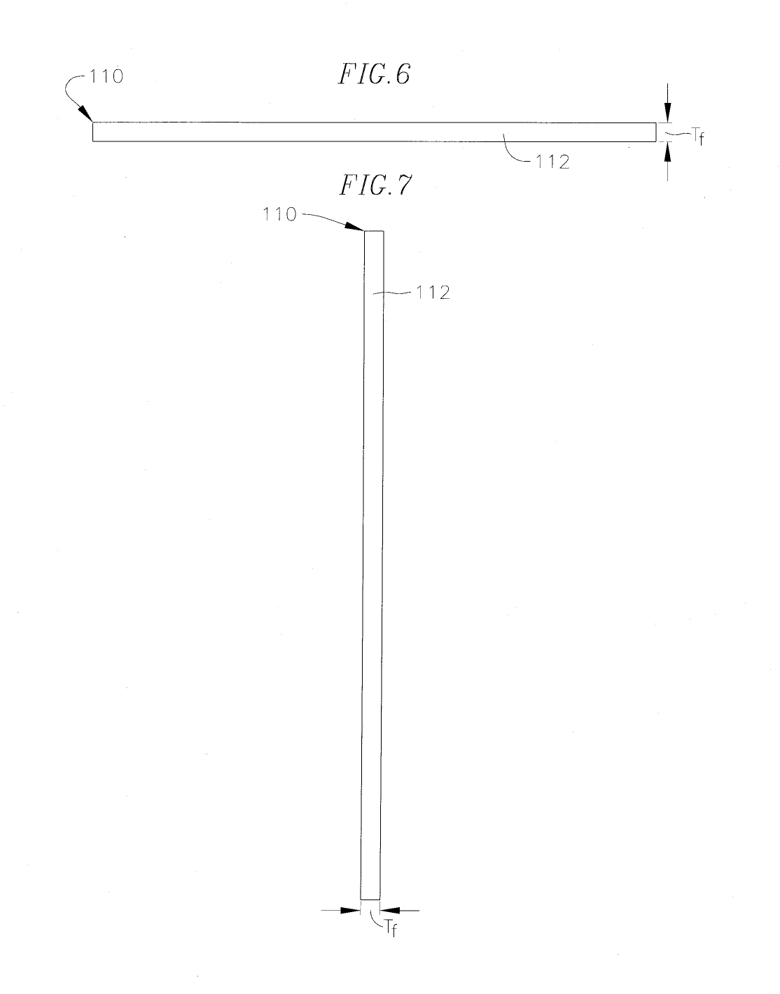

The flyer sheet 110 is a sheet of material 112 (see FIG. 3), for example, a printable sheet of material (e.g., a cardstock sheet); printable paper; printable film (e.g., polyethylene terephthalate (“PET”) from DuPont Teijin Films in Chester, Virginia, to which may be applied an inkjet coating, or the film is configured for laser printing); nonwoven materials (e.g., TYVEK from E. I. du Pont de Nemours and Company in Wilmington, Del.); polyolefins such as, for example, polyethylene and polypropylene; and laminates thereof. The flyer sheet 110 can have various dimensions (e.g., W by L), for example, the flyer sheet 110 can be 8½ inches by 11 inches (21.59 centimeters by 27.94 centimeters, hereinafter “cm”), 8½ inches by 14 inches (21.59 cm by 35.56 cm), 11 inches by 17 inches (27.94 cm by 43.18 cm), A3 size, A4 size, and other sizes that can be printed upon by a desktop printer or a copier. The flyer sheet 110 can be approximately 140 grams per square meter (“gsm”) to approximately 176 gsm in weight. Also, in some embodiments, a flyer sheet 150 can include a top and/or bottom non-cured coating 113 (see FIGS. 4 and 5). Suitable coatings 113 can include print-receptive coatings, for example, ink jet coatings, toner adhesion enhancing coatings, anti-static coatings, and anti-slip coatings, and others known to those of skill in the art.

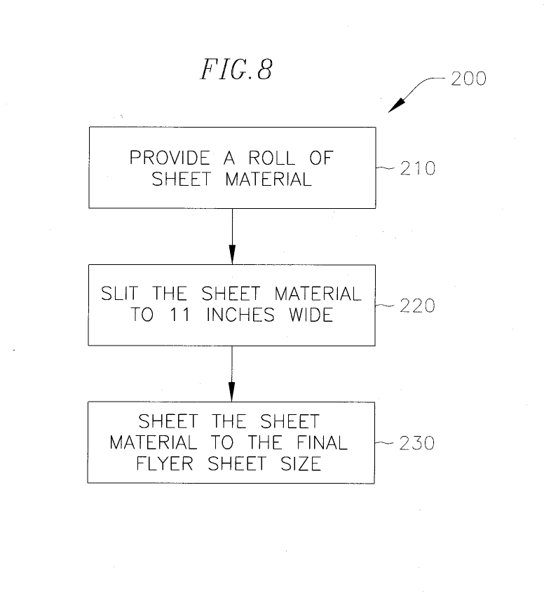

The thickness T_{f} of the flyer sheet 150, as shown in FIG. 4, can range from approximately 0.0045 inch to approximately 0.010 inch (0.0045 millimeter to approximately 0.254 millimeter, hereinafter “mm”). An example of the flyer sheet material 112 is NEENAH CLASSIC CREST 65# cover stock, which is manufactured by Neenah Paper, Inc. of Alpharetta, Georgia. In one exemplary embodiment, the flyer sheet 150 has a thickness T_{f} approximately of 0.0087 inch (0.2210 mm). In another exemplary embodiment, the flyer sheet 150 has a thickness T_{f} of approximately 0.0072 inch (0.1829 mm) The thickness T_{f} of the flyer sheet 150 in exemplary embodiments of the flyer assembly 100 can be such that the flyer sheet 150 can pass through an input tray 116 of a printer 115, and out an output tray 117, in a manner similar to printing operations performed on a pad sheet 130, as shown in FIG. 32. For example, a consumer 126 (e.g., a small business owner) may print indicia 111 on an exemplary flyer sheet 110, 150 using a printer 115, for example, a desktop printer. The printing operations that are performed on the flyer sheet 110, 150 and/or the pad sheet 130 (as shown in FIGS. 9 and 32) by the printer 115 can be regulated by computer-driven software that is used to control the printer 115 and to provide, for example, by use of graphical templates, the consumer/user 126 with a graphical user interface that facilitates the printing of user-selected information/content 111, 122, 135 to the flyer sheet 110, 150 and/or pad sheet 130 (as shown in FIGS. 9 and 32). FIG. 6 is a top edge view of an embodiment the flyer sheet 110 without a top and/or bottom non-cured coating 113, and FIG. 7 is a side elevational view of the flyer sheet 110 shown in FIG. 6. While the example embodiment of the flyer sheet 110 shown in FIG. 3 is rectangular in shape, the flyer sheet 110 can have a shape that is not rectangular, for example, the flyer sheet 110 can have a square shape, an oval shape, or a circular shape. Alternatively, the flyer sheet 110 can be a die cut shape in a larger sheet that can be punched out or separated from waste portions. In this fashion, a wide variety of flyer sheet 110 shapes are possible.

During manufacturing, the flyer sheet 110 is sheeted from a roll of stock or sheet material 112, as shown in the method 200 in FIG. 8. In one embodiment method 200, as outlined in the flow chart shown in FIG. 8, a roll of stock or sheet material 112 is provided in step 210. The roll of stock or sheet material 112 is slit into 11 inch (27.94 cm) wide rolls of material in step 220. Alternatively, the roll of stock or sheet material 112 can be provided already slit into 11 inch (27.94 cm) wide rolls. Next, the slit roll is sheeted on a web-fed machine into 8½ inch by 11 inch (21.59 cm by 27.94 cm) sheets in step 230.

The rows of coupons 120 that, during use, are coupled to the flyer sheet 110, are formed as part of a pad sheet 130. A front elevation view of an example embodiment of the pad sheet 130 is shown in FIG. 9, and the corresponding back elevational view of the example embodiment of the pad sheet 130 is shown in FIG. 10. The example pad sheet 130, as shown in FIG. 11, includes a base sheet of material 131, strips of adhesive 132, and strips of liner 133. The base sheet of material 131, for example a printable sheet of material (e.g., can be the same materials used for the flyer sheet 110), can be in various shapes and have various dimensions (e.g., Wₚ by Lₚ), for example, the pad sheet 130 can be 8½ inches by 11 inches (21.59 cm by 27.94 cm), 8½ inches by 14 inches (21.59 cm by 35.56 cm), 11 inches by 17 inches (27.94 cm by 43.18 cm), A3 size, A4 size, and other sizes that can be printed upon by a desktop printer 115 or a copier. Also, in some embodiments, the base sheet 131 of the pad sheet 160 may include a top and/or bottom non-cured coating 134 (as shown in FIG. 16). Suitable coatings 134 can include print-receptive coatings, for example, ink jet coatings, toner adhesion enhancing coatings, anti-static coatings, and anti-slip coatings, and others known to those of skill in the art.

The thickness T_{b} of the base sheet 131 (as shown in FIG. 11) can range from approximately 0.0045 inch to approximately 0.010 inch (0.1143 mm to approximately 0.254 mm). In one exemplary embodiment, the base sheet 131 has a thickness T_{b} approximately of 0.0087 inch (0.2210 mm). In another exemplary embodiment, the base sheet 131 has a thickness T_{b} of approximately 0.0072 inch (0.1829 mm). The thickness T_{b} of the base sheet 131 in exemplary embodiments of the flyer assembly 100 can be such that the entire pad sheet 130, including the base sheet 131, the strips of adhesive 132, and the strips of liner 133, can pass through a printer 115, as shown in FIG. 32. For example, a consumer 126 (e.g., a small business owner) may print indicia 135 on an exemplary pad sheet 130 using a printer 115, for example, a desktop printer. During manufacturing, the base sheet 131 can be formed from a roll of stock material that is slit into rolls of material, for example, 11 inch (27.94 cm) wide slit rolls. These slit rolls ultimately are sheeted into 8½ inch (21.59 cm) wide sheets. The sheeting step can occur after the manufacturing steps of the various other components of the pad sheet 130, as discussed in greater detail below.

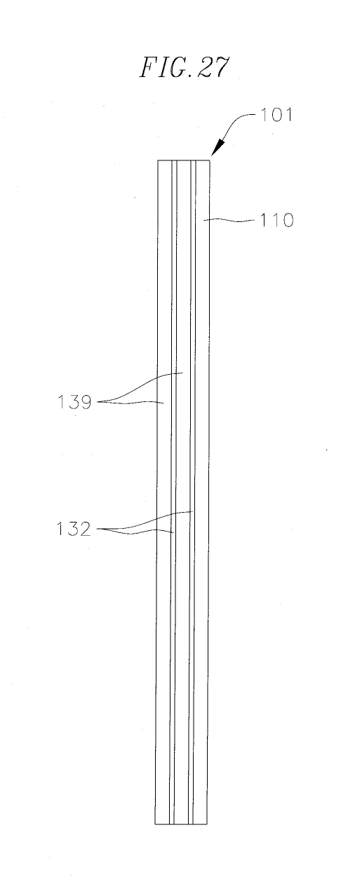

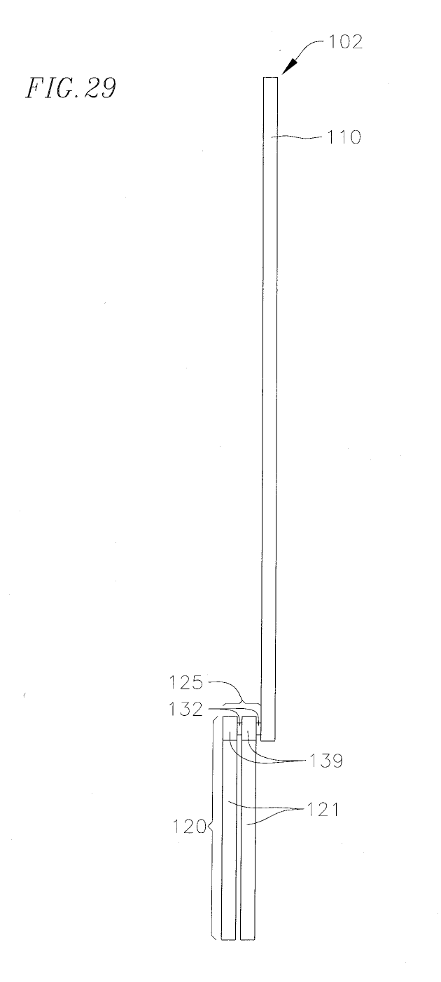

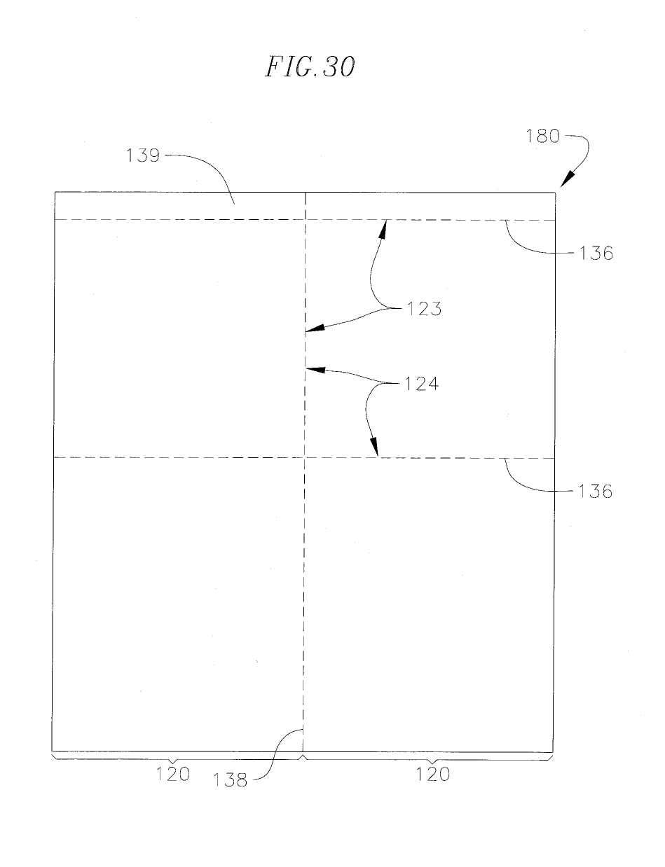

The example pad sheet 130, as illustrated in FIGS. 9 and 10, is an 8½ inches by 11 inches (21.59 cm by 27.94 cm) cardstock sheet that can be separated along row separation lines 137 into rows of coupons 120 that are stacked one on top of the other by a user 126 to form a pad of coupons 125 (as shown in FIGS. 26 and 29). While the coupons 121 (also referred to as coupon portions) shown in FIGS. 9 and 10 are rectangular in shape, the coupons 121 can be other shapes in additional embodiments. For example, in other embodiments, the coupons 121 can be square, oval, or semi-circular in shape. Alternatively, the coupons 121 can be die cut shapes in larger coupons 121 that can be punched out or separated from waste portions. In this fashion, a wide variety of coupon 121 shapes are possible.

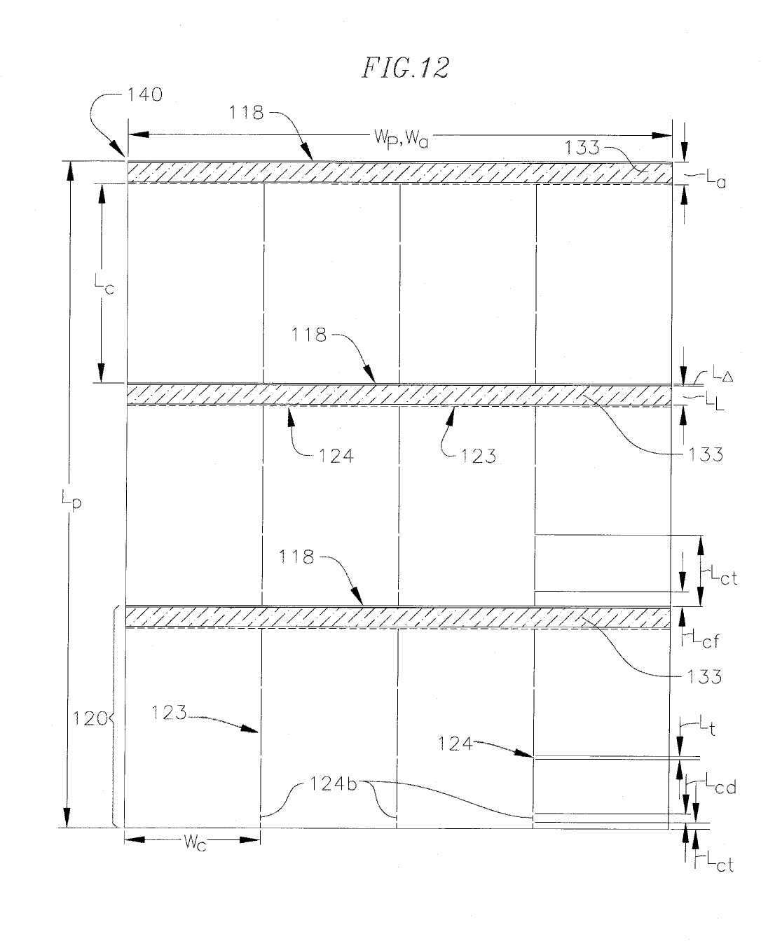

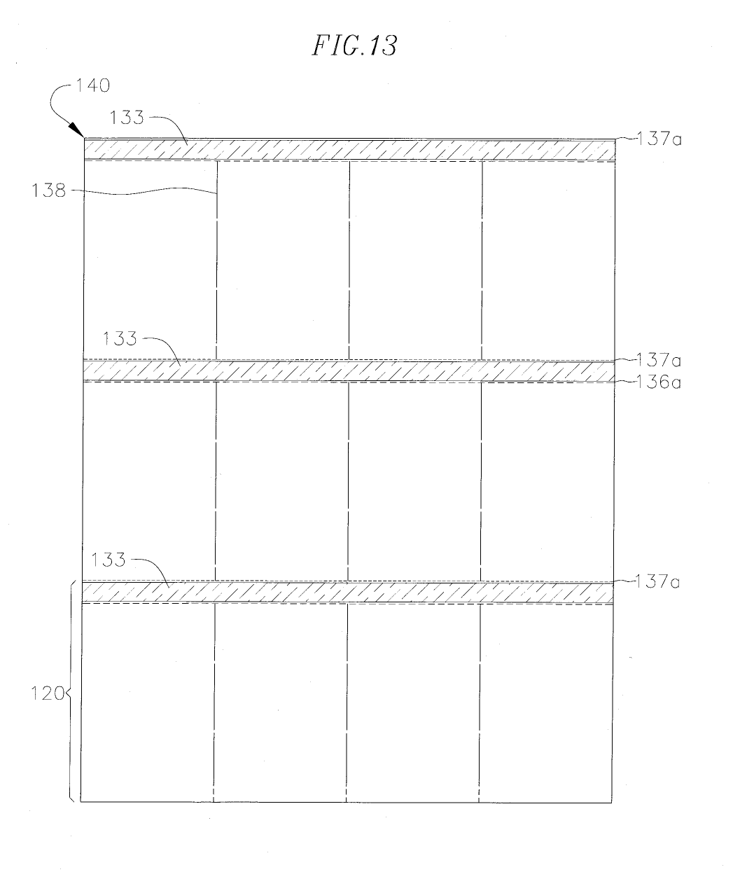

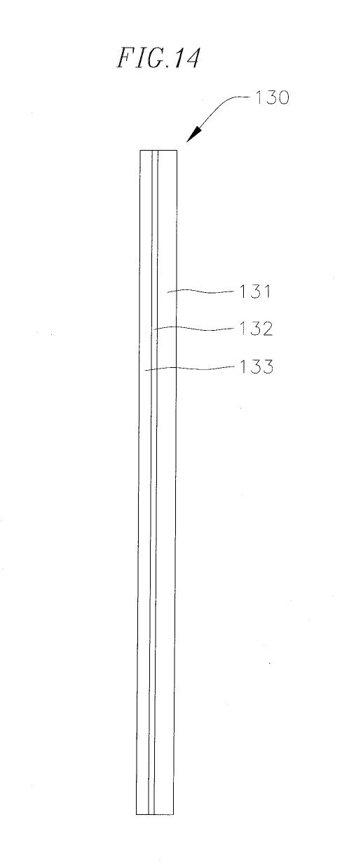

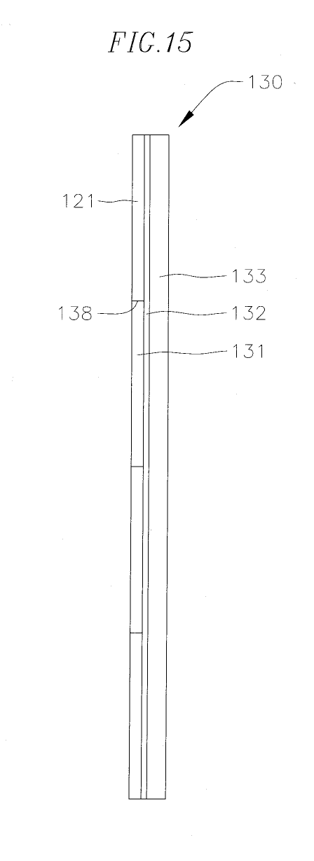

The shape of the rows of coupons 120, which includes an anchor strip 139 and the accompanying individual coupons 121 in each row of coupons 120, is defined by the various edges 119a, 119b, 119c of the base sheet 131 (e.g., the top edge 119a, the bottom edge 119b, and the left side and right side edges 119c, of the base sheet 131, as shown in FIGS. 9 and 10) in combination with the various perforation lines 136a and separation lines 136, 137, 138 that are formed in the base sheet 131. In one embodiment, the base sheet 131 includes row separation lines 137, including two horizontal microperforation lines 137a that extend between the two side edges 119c of the base sheet 131. FIGS. 12 and 13 are back elevational views of another embodiment of a pad sheet 140. In one embodiment, the microperforation lines 137a are vertically evenly spaced to define three coupon rows 120 having a width W_{c} of approximately 8½ inches (21.59 cm) and length L_{c} of approximately 3⅔ inches (9.313 cm), as shown in FIGS. 12 and 13. The microperforation lines 137a include a repeating pattern of through cuts 123a and ties 124a, as shown in FIG. 9. and in example embodiments, the cuts 123a are approximately 0.01 inch (0.254 mm) in length and the ties 124a are approximately 0.005 inch (0.127 mm) in length.

Referring back to FIGS. 9, 10, and 12, the example pad sheet 130 also includes horizontal coupon separation lines 136 that are parallel to row separation lines 137. The horizontal coupon separation lines 136 include three perforated lines 136a extending between the two side edges 119c of the base sheet 131, and between each anchor strip 139 and the accompanying individual coupons 121, having cuts 123 with lengths of approximately 0.125 inch (3.175 mm) and ties 124 of approximately 0.031 inch (0.787 mm). Each of the three perforated lines 136a is located approximately ⅜ inch (9.525 mm) below a top edge 118 of a respective one of the coupon rows 120, thereby defining an example anchor strip 139 as having a width Wₐ of approximately 8½ inches (21.59 cm) and a length Lₐ of approximately ⅜ inch (9.525 mm) at the top 118 of each coupon row 120 (as shown in FIG. 12). The anchor strip 139 along a top edge 119a of the base sheet 131 includes horizontal separation lines 136 along one side 139a of the anchor strip 139 (as shown in FIGS. 9 and 10). In other embodiments, the adhesive of the adhesive strip 132 is a removable, repositionable, or ultra-removable adhesive, there is no perforated line 136a between each anchor strip 139 and the accompanying individual coupon 121, and there are perforation lines 136a in the anchor strip 139 that align with the coupon 121 edges 121a (top edge), 121b (bottom edge), as shown in FIG. 10.

Other configurations or lengths of cuts 123a, 123 and ties 124a, 124 can be used for the microperforated lines 137a and the perforated lines 136a, respectively. In the embodiment described above, the microperforated lines 137a and the perforated lines 136a are configured such that when a consumer 126 folds the pad sheet 130 to facilitate separating the coupon rows 120, the pad sheet 130 folds at the microperforated lines 137a. The consumer 126 can then easily separate the coupon rows 120 along the microperforated lines 137a without weakening or tearing the perforated lines 136a.

With reference to FIGS. 9 and 12, each coupon row 120 further includes three vertical coupon separation lines 138 that extend perpendicular to the horizontal coupon separation lines 136. The vertical coupon separation lines 138 each include cuts 123 with lengths L_{ct} approximately 1.05 inch (26.67 mm) long separated by ties 124 having a length Lₜ of approximately 1/20 inch (1.27 mm) In other embodiments, the length L_{ct} of the cuts 123 and the length Lₜ of the ties 124 can be longer or shorter. In some embodiments, the length L_{cf} of a first cut 123 may vary from the length L_{ct} of the typical cuts 123, for example the length L_{cf} may be 0.125 inch (3.175 mm), while the length L_{ct} of the remaining cuts 123 may be 1.1884 inches (30.185 mm).

Any length L_{ct} of the cuts 123 and length Lₜ of the ties 124 that facilitates separation of a coupon 121 from adjacent coupon(s) 121 can be used. In yet other embodiments, as seen in FIGS. 12 and 13, ties 124 can be positioned close to one another forming double ties 124b, with a cut 123 between the double ties 124b having a length L_{cd}. Together with a respective perforation line 136a, the vertical coupon separation lines 138 define four coupons 121 having a width, W_{c}, for example approximately 2⅛ inches (5.398 cm) wide.

Referring additionally to FIGS. 11, 14, and 15, which are side elevational, top edge plan, and bottom edge plan views, respectively, of the example embodiment of a pad sheet 130, a strip of adhesive 132 (which can include a strip of liner 133 covering the adhesive strip 132, as is highlighted in diagonal lines in FIG. 12) is coupled to a back surface 139b of each anchor strip 139. In example embodiments, the adhesive strip 132 is made of permanent adhesive, repositionable adhesive, removable, or ultra-removable adhesive. The adhesive can be ethylene vinyl acetate (“EVA”) or rubber-based hot melt adhesives, for example, the SCOTCH-WELD adhesives made by 3M of St. Paul, Minn. Alternatively, the adhesive can be solvent-based or water-based acrylic adhesives, for example, S-490 or AT-1, respectively, from Avery Dennison Corporation of Pasadena, Calif.

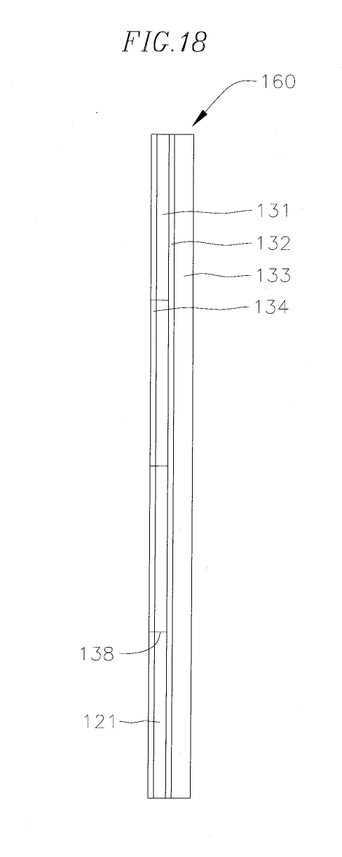

Another embodiment of an example pad sheet 160 is shown in FIGS. 16 through 18. The embodiment shown in FIGS. 16 through 18 includes a coating 134 on the side 131a of the base sheet 131 opposite the side 131b including adhesive strips 132 and liner strips 133. Suitable coatings 134 can include print-receptive coatings, for example, ink-jet coatings, toner adhesion enhancing coatings, anti-static coatings, and anti-slip coatings, and others known to those of skill in the art.

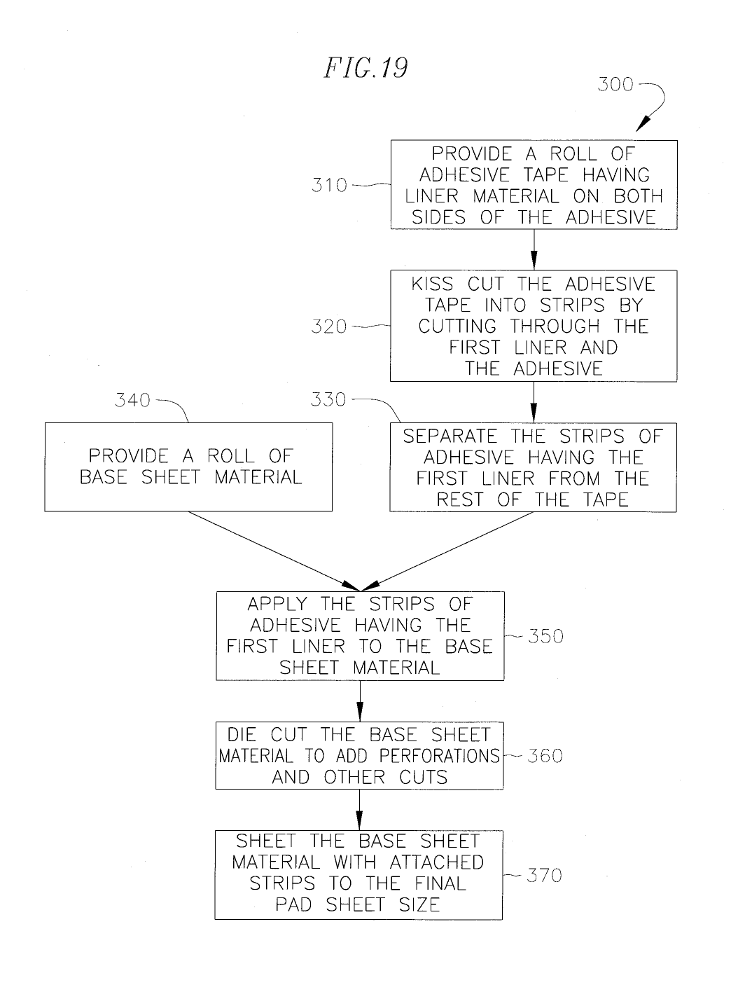

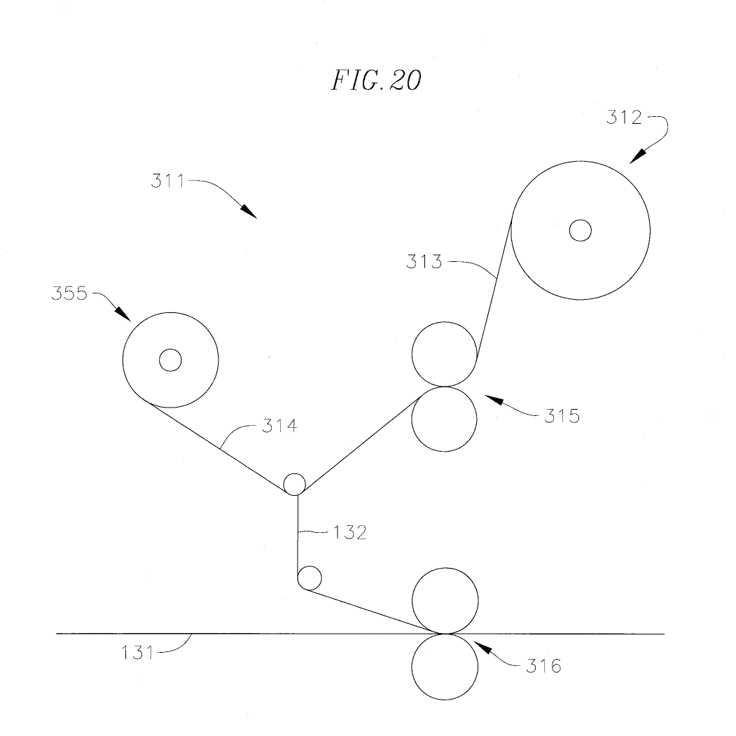

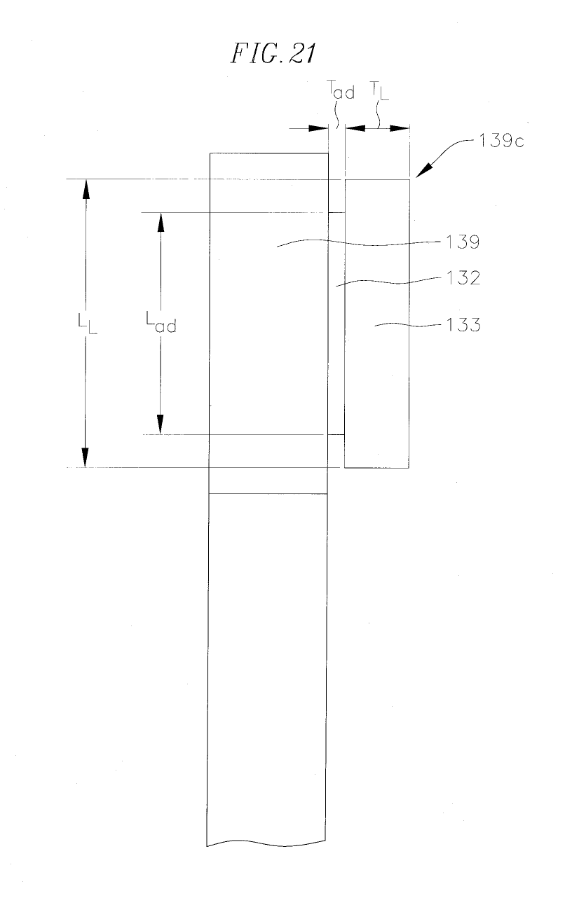

During manufacturing, the strip of adhesive 132 is applied to the anchor strip 139 using, for example, a coating or printing process, for example, a XONAD process (Avery Dennison Corporation, Pasadena, Calif.), and the adhesive strip 132 can extend from one side edge 119c of the pad sheet 130 to the other side edge 119c. Alternatively, the adhesive strip 132 can be discontinuous and includes segments of adhesive that together form a stripe. Strips of release liner 133 can be slit and applied over the adhesive strips or segments 132 before perforations 136a, 137a and cuts 123, 123a and ties 124, 124a are formed in the base material sheet 131. In another example manufacturing process 300, the adhesive strip 132 is an adhesive tape 313 (as shown in FIG. 20) that is applied to the base sheet 131. The flow chart 300 in FIG. 19 outlines this example embodiment. In one step 310, a roll of adhesive tape 313 is provided. In another step 340, a roll of base material 131 is provided. The adhesive tape 313 provided is a roll of adhesive tape 313 having different liner material on either side of the adhesive material and is known as a transfer tape. The adhesive has greater adhesion to the first liner than to the second liner. The adhesive tape 313 is slit to approximately nine inch (22.86 cm) wide rolls from a master roll in a separate process. The slit roll 312 of the adhesive tape 313 is run on a press 311 at the same time as a roll of base sheet material 131. In another step 320, the transfer tape is kiss cut into adhesive strips 132 by cutting through the first liner and adhesive, but not the second liner, at die station 315, and in another step 330, the adhesive strips 132 are peeled off the slit roll 312 of adhesive tape 313. In another step 350, after the adhesive strips 132 are peeled off of the slit roll 312, the adhesive strips 132 are attached to the base sheet material 131 in a nip 316. The remaining transfer tape material 314 that has the adhesive strips 132 removed is rewound at 355 (as shown in FIG. 20). In another step 360, perforations 136a, 137a and other cuts 123, 123a and ties 124, 124a are formed in the base sheet material 131. In yet another step 370, the base sheet material 131 with the attached adhesive strips 132 is sheeted into the final pad sheet 130 size. A schematic of a machine 311 useful for applying the adhesive strips 132 to the base sheet material 131 is shown in FIG. 20.

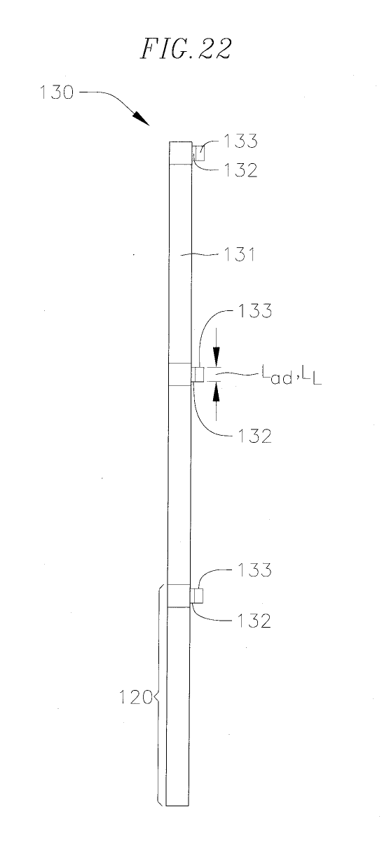

The adhesive strip 132 used in the process 300 shown in FIGS. 19 and 20 can have a thickness T_{ad} (as shown in FIG. 21), for example, from approximately 0.0003 inch to approximately 0.001 inch (0.007 mm to approximately 0.025 mm). In example embodiments, the thickness T_{ad} of the adhesive strip 132 is approximately 0.0004 inch (0.0102 mm), and, in another example embodiment, the thickness T_{ad} of the adhesive strip 132 is approximately 0.001 inch (0.0254 mm). Also, the length L_{ad} of the adhesive strip 132 can be, for example, from approximately 0.125 inch to approximately 0.375 inch (3.175 mm to approximately 9.525 mm). In example embodiments, the thickness T_{ad} of the adhesive strip 132 is approximately 0.25 inch (6.35 mm), and, in another example embodiment, the thickness T_{ad} of the adhesive strip 132 is approximately 0.125 inch (3.175 mm). While the strips of adhesive 132 can be rectangular in shape, the strips of adhesive 132 can be other shapes, for example, curved shapes, wavy shapes, or any other shape that falls within the boundary of the anchor strip 139.

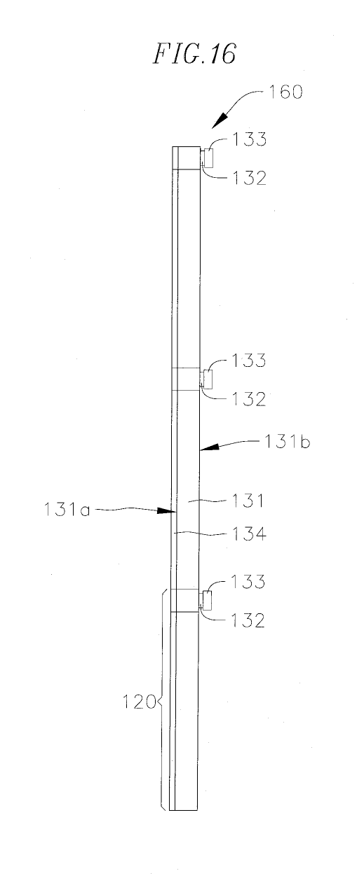

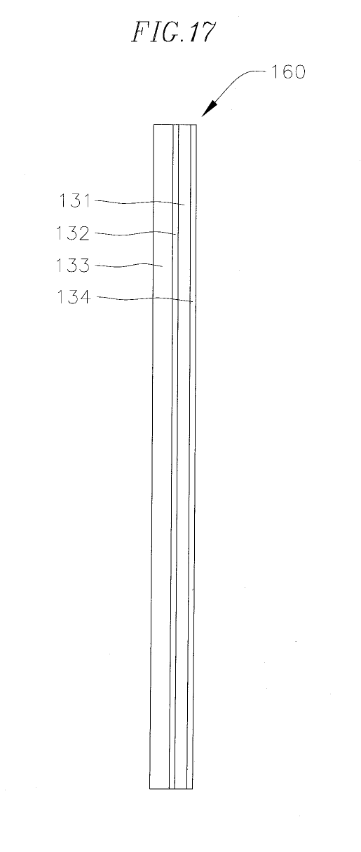

As shown in FIGS. 11, 14, and 15, the adhesive strip 132 is protected in the example embodiment by a strip of release liner 133, also known as a liner. Examples of material that the strip of liner 133 can be made of include the following: release coated papers and release coated films. Example liner strip 133 materials include POLY SLIK and PRIMELINER from Loparex LLC in Cary, N.C. The strip of liner 133 is coupled to the rest of the pad sheet 130 by a strip of adhesive 132. The liner 133 is not visible from the front of the pad sheet 130, but is visible when viewing the pad sheet 130 from the side (as shown in FIG. 11), the back, and the top and/or bottom edges (as shown in FIGS. 14 and 15). In example embodiments, the strip of liner 133 can have a coating on the top 133a and/or bottom 133b surfaces, which is configured to be releasably coupled to the strip of adhesive 132. Transfer tapes that include a single liner 133 material with release coatings on both sides 133a, 133b are known to those of ordinary skill in the art as self-wound transfer tapes.

The strips of liner 133 can have a thickness T_{L} (as shown in FIG. 21), for example, from approximately 0.0004 inch to approximately 0.003 inch (0.0102 mm to approximately 0.0762 mm). In example embodiments, the thickness T_{L} of the strips of liner 133 is approximately 0.0026 inch (0.0660 mm), and, in another example embodiment, the thickness T_{L} of the strips of liner 133 is approximately 0.0004 inch (0.0102 mm). Also, the length L_{L} of the strips of liner 133 can be, for example, from approximately 0.125 inch to approximately 0.375 inch (3.175 mm to approximately 9.525 mm). In example embodiments, the length L_{L} of the strips of liner 133 is approximately ¼ inch (6.36 mm), as shown in FIG. 12, and, in another example embodiment, the thickness T_{L} of the strips of liner 133 is approximately 0.125 inch (3.175 mm).

In example embodiments, the strips of liner 133 extend from one side edge 119c of the pad sheet 130 to the other side edge 119c. In other embodiments, the strips of liner 133 do not extend from one side edge 119c of the pad sheet 130 to the other side edge 119c, while still covering the adhesive strip 132 on a back surface 130b of the pad sheet 130. Also, the strips of liner 133 can be rectangular in shape in certain example embodiments, and other shapes, for example, the liner 133 can include wavy edges, in other example embodiments.

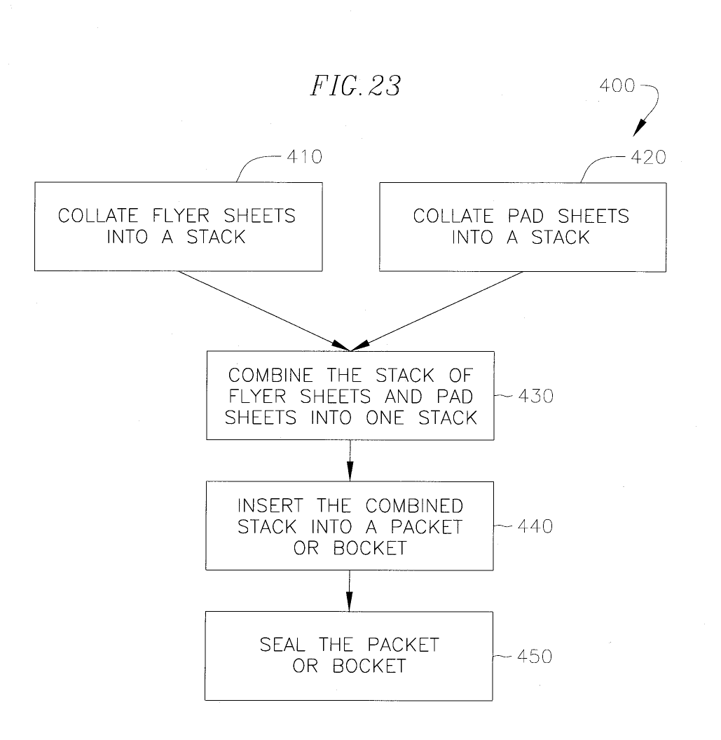

FIG. 21 shows an expanded partial side elevation view of a portion 139c of an anchor strip 139, an adhesive strip 132, and a corresponding strip of liner 133. As shown in FIG. 21, the length L_{L} of the strip of liner 133 is greater than the length L_{ad} of the strip of adhesive 132. In other example embodiments, as shown in FIG. 22, the length L_{L} of the strip of liner 133 can be the same or approximately the same as the length L_{ad} of the strip of adhesive 132. In other embodiments as shown in FIG. 12, the length L_{L} of the strip of liner 133 is less than the length Lₐ of the anchor strip 139, creating a difference in length L_{Δ} between a top edge of the coupon row 118 and the strip of liner 133, such that the overall length L_{L} of the strip of liner 133 is 2L_{Δ} less than the length Lₐ of the anchor strip 139 between row separation line 137 and horizontal separation line 136. In example embodiments, the length Lₐ of the anchor strip 139 is ⅜ inch (9.525 mm), while the length L_{L} of the strip of liner 133 is ¼ inch (6.35 mm), such that there is a difference in length 2L_{Δ} between the anchor strip 139 and the strip of liner 133 of ⅛ inch (3.175 mm), or a difference in length L_{Δ} between the top edge of the coupon row 118 and the strip of liner 133 of 1/16 inch (1.588 mm).

During manufacturing, in one example embodiment, the web having the base sheet 131 material, the adhesive strips 132, and the liner strips 133, passes through a first die station 315, which cuts the perforations 136a, microperforations 137a, and/or cuts 123, 123a and ties 124, 124a running in the machine direction. Next, a second die station 315 cuts the perforations 136a, microperforations 137a, and/or cuts 123. 123a and ties 124, 124a in the cross direction. Finally, the web of base material 131, adhesive strips 132, and liner strips 133 is sheeted, for example, into 8½ inch (21.59 cm) wide sheets.

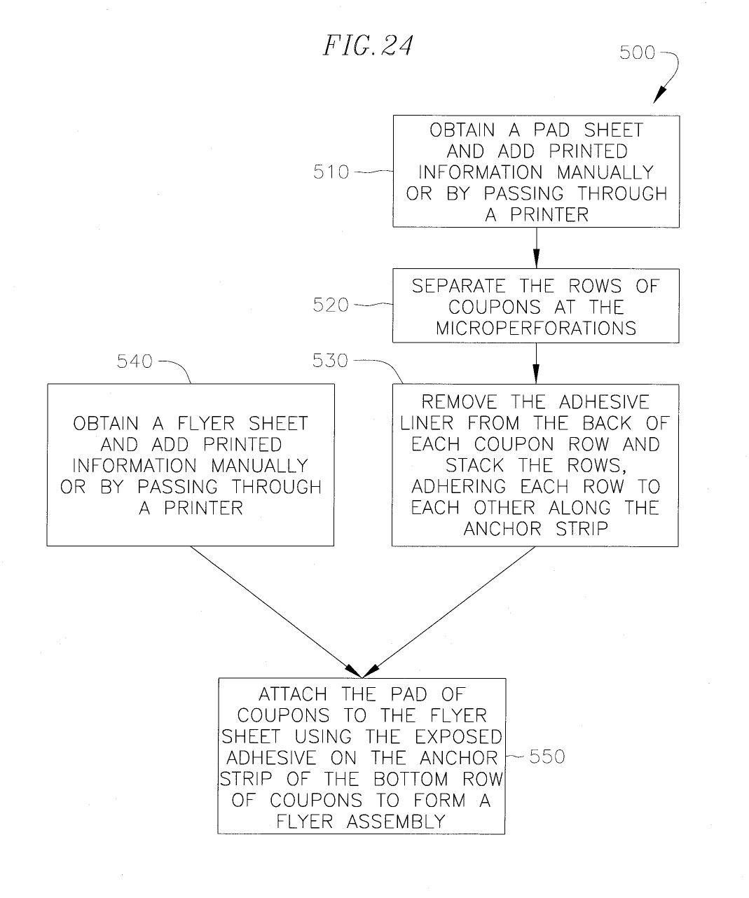

A method 400 of packaging the flyer sheet 110 and pad sheets 130 is shown in FIG. 23. In one step 410, one or more flyer sheets 110 is collated and stacked. In another step 420, one or more pad sheets 130 are collated and stacked. The stacked flyer sheets 110 and the stacked pad sheets 130 are combined, along with other literature sheet(s) (if present), in another step 430, followed by the combined flyer sheet(s) 110, pad sheet(s) 130, and/or literature sheet(s) being inserted at step 440 into a packet or bocket. In a final step 450, the packet or bocket is sealed.

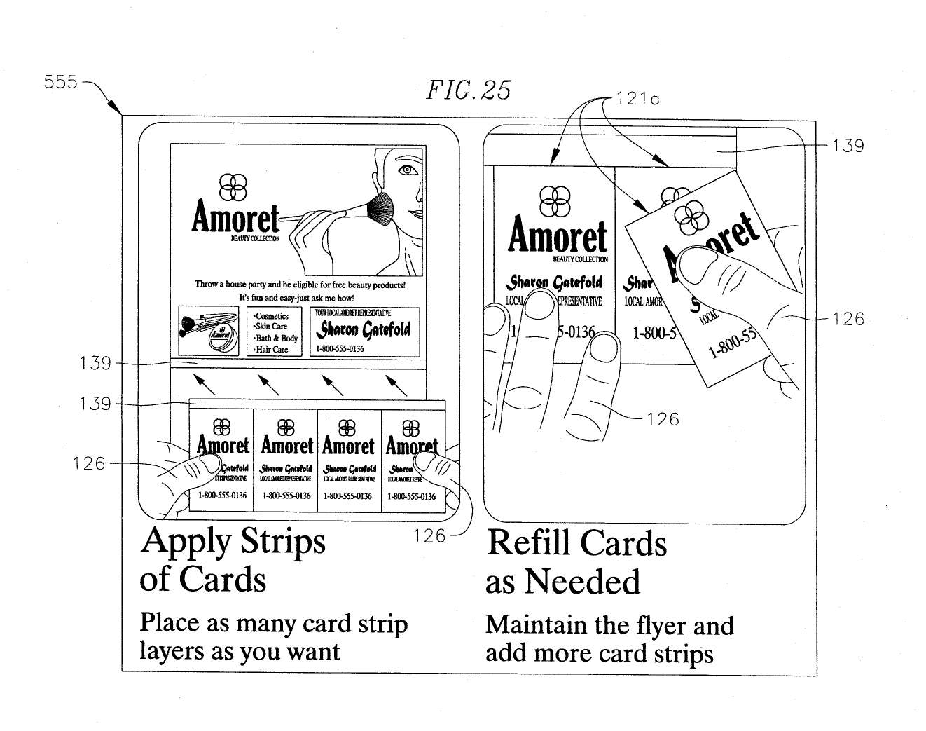

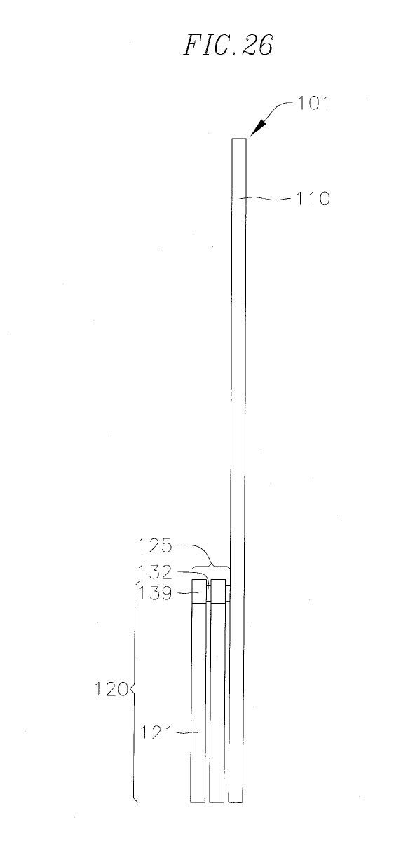

A method 500 of assembling a flyer assembly 100 is shown in FIG. 24. In a first step 510, the consumer/user 126 would print information 135 on a pad sheet 130, and, in particular, on each of the coupons 121 (e.g., coupons or contact information 122, etc.). After printing, in another step 520, the rows of coupons 120 would be separated at the microperforation lines 137a from each other. After removal of the liner 133, the rows of coupons 120 are stacked one upon one the other in step 530. In a separate step 540, the flyer sheet 110 is printed. In a final step 550, the stack of rows of coupons 120 is adhered to the flyer sheet 110. In an alternative method 555, instead of stacking the rows of coupons 120 one upon the other, each row of coupons 120 can be applied to the printed flyer sheet 110 or to a row of coupons 120 already attached to the flyer sheet 110 (as shown in FIG. 25). A user 126 can then apply additional rows of coupons 120 resulting in a stack of a plurality of rows of coupons 120. Throughout this application, the word “plurality” means two or more.

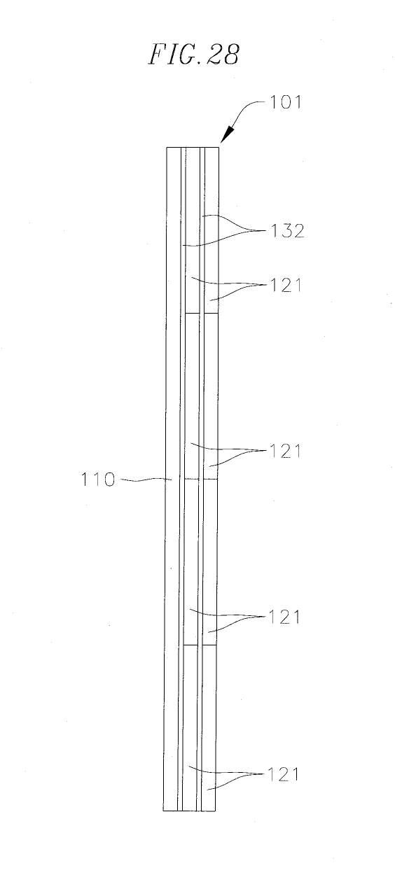

FIG. 26 is a side elevational illustration (and FIGS. 27 and 28 are corresponding top edge and bottom edge illustrations, respectively) of two rows of coupons 120 that have been coupled to a flyer sheet 110 of a flyer sheet assembly 101 according to another embodiment. In FIG. 26, the strip of adhesive 132 on the back surface of the anchor strip 139 of top coupon row 120 is coupled to the anchor strip 139 of the underlying row of coupons 120, and the strip of adhesive 132 of that row of coupons 120, in turn, is coupled to the flyer sheet 110. As shown in the side elevation illustration of FIG. 29, in other example embodiment of a flyer sheet assembly 102, the relative position of the rows of coupons 120 to the flyer sheet 110 can be different from that of the position shown in FIG. 26 based on the preference of the user 126. At some point in the process of constructing the flyer assembly 102, the user 126 would couple the flyer sheet 110 to a supporting surface 129 (e.g., a bulletin board), either before or after the row(s) of coupons 120 is coupled to the flyer sheet 110 (see FIGS. 1 and 2).

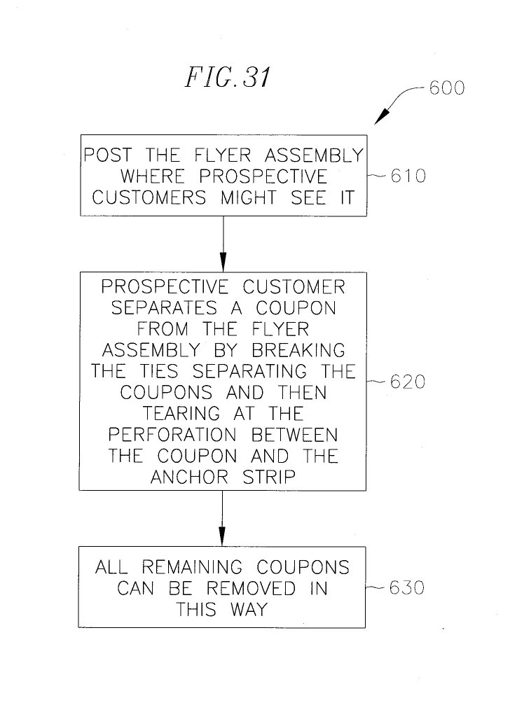

While the previous discussion has focused on removing the coupons 121 as rows 120 from the remaining portion of the pad sheet 130, an individual having ordinary skill in the art understands that the coupons 121 can be applied to the flyer sheet 110 vertically as a column of coupons 120 instead of (or in addition to) horizontally as a row of coupons 120. In such a configuration, the row of coupons 120 can be applied vertically instead of horizontally so that the anchor strip 139 is vertically aligned. In another example embodiment, the anchor strip 139 includes vertical perforation lines 136a, in addition to the horizontally oriented microperforation lines 137a and perforated lines 136a, that are aligned with the cuts 123, 123a and ties 124, 124a, i.e., the cuts 123, 123a and ties 124, 124a that make up the separation lines 136, 137, 138 that separate adjacent coupons 121. In such an embodiment, the coupons 121 can be removed as a column of coupons 120 (or as a row of coupons 120 as previously discussed), and then can be applied to the flyer sheet 110 or to another underlying column of coupons 120. Additionally, the pad sheet 130, for example the embodiment shown in FIG. 9, can be separated along the vertical coupon separation lines 138 to form vertical coupon rows 120 that could be attached to a side edge 119c of the flyer sheet 110. In yet another embodiment, a pad sheet 180 can be formed with a single anchor strip 139 along an edge as shown in FIG. 30. A number of horizontal coupon separation lines 136 can be formed in the pad sheet 130, along with a number of vertical coupon separation lines 138. The coupon rows 120 can be separated along the vertical coupon separation lines 138 to form a column of coupons 120 that can be applied to the flyer sheet 110 (as shown in FIG. 30).

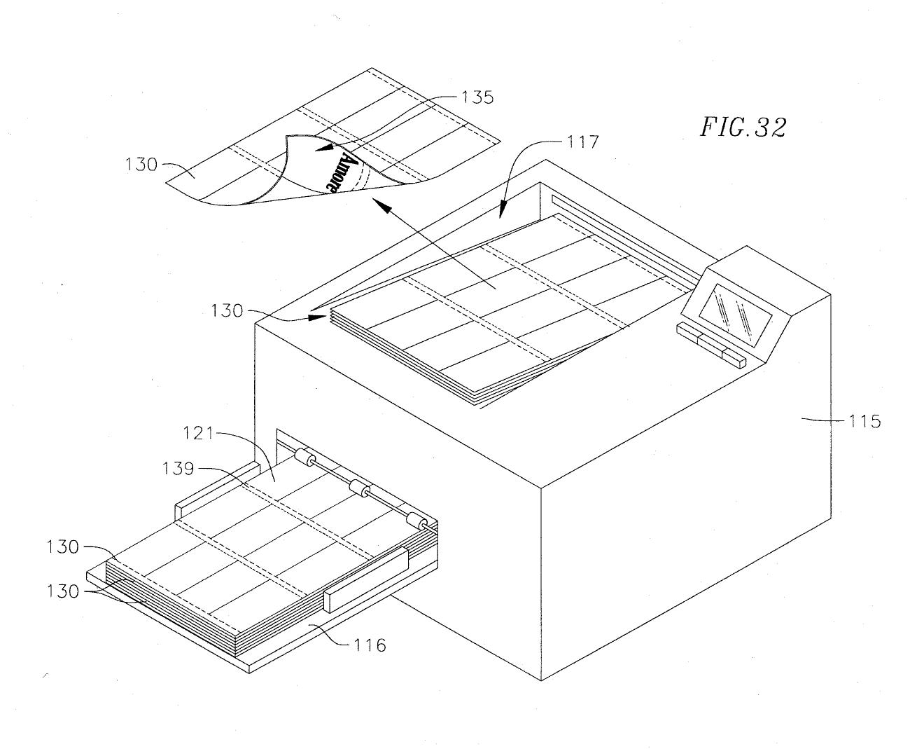

A method 600 of using the flyer assembly 100 is shown in FIG. 31, in which in a first step 610, an individual or consumer 126 posts the flyer assembly 100 for an individual or prospective customer 126. In a subsequent step 620, an individual or prospective customer 126, who views the assembled flyer sheet 110 and is interested in having a coupon 121 would then detach one of the coupons 121 by breaking the ties 124 along the vertical coupon separation line 138 between the adjacent coupon(s) 121, and then tearing the perforation 136a along the horizontal coupon separation line 136, as shown in FIGS. 1 and 2. In subsequent steps 630, additional coupons 121 are removed from the flyer assembly 100 in the same or similar manner. Later, a user 126 can apply an additional row, or rows, of coupons 120 to refill/replenish the total number of coupons 121 that are coupled to the flyer sheet 110. This is done without having to remove the flyer sheet 110 from the underlying surface 129 (e.g., a bulletin board), and without having to replace the flyer sheet 110.

Although the flyer sheets 110 and pad sheets 130 described herein are printable in inkjet and laser printers 115 and copiers, it should be understood that in addition to, or instead of, printing in a printing device 115, the flyer sheets 110 and pad sheets 130 can be configured to accept hand-applied markings. For example, hand-applied marking methods can include markings and/or indicia 111, 122, 135 applied with a pen, pencil, marker, chalk, dry-erase marker, crayon, or with paint or a stamp. In addition to or instead of bearing markings of the type that can be hand-applied and/or made using a printing device 115, other types of textual and/or non-textual matter can be adhered or otherwise secured to the flyer sheet 110 or pad sheet 130.

Advantageously, the present invention allows the individual 126 who posted the flyer 100 to apply any desired number of coupons 121 to the flyer 100, but also to print additional rows of coupons 120, and apply the new coupons 121 to the flyer sheet 110 when the original coupons 121 are used without having to reprint the flyer sheet 110. Accordingly, the present invention does not require that the entire flyer sheet 110 be reprinted. Also, the coupons 121 are precut, so that the individual 126 who prepared the flyer assembly 100 need not cut the coupons 121. Furthermore, the top edge 121a of the coupons 121 are perforated, thus easing the user's 126 removal of the coupon 121, and allowing for the removed coupon 121 to retain its shape and reduce the likelihood of the coupon 121 being damaged during removal from the flyer assembly 100.

All features disclosed herein (including the drawings), and all steps in any method or process disclosed, can be combined in any combination, except combinations where at least some of such features and/or steps are mutually exclusive. Each feature disclosed herein (including the drawings) can be replaced by alternative features serving the same, equivalent, or similar purpose, unless expressly stated otherwise. Thus, unless expressly stated otherwise, each feature disclosed is one example only of a generic series of equivalent or similar features.

The foregoing detailed description of the present invention is provided for purposes of illustration, and it is not intended to be exhaustive or to limit the invention to the particular embodiments disclosed. The embodiments can provide different capabilities and benefits, depending on the configuration used to implement the key features of the invention.

What is claimed is:

1. An apparatus comprising:
a pad sheet that includes:
a) at least one coupon; and
b) at least one anchor strip that is coupled to the at least one coupon.

2. The apparatus of claim 1, wherein the pad sheet further includes:
a) a base sheet from which the at least one coupon and the at least one anchor strip is formed, and
b) the base sheet is made of a material selected from the group consisting of cardstock sheet, printable papers, printable films, non-woven materials, polyolefin materials, and laminates thereof.

3. The apparatus of claim 1, wherein the pad sheet has a size selected from the group consisting of A3, A4, 8½ inches by 11 inches, 8½ inches by 14 inches, 11 inches by 17 inches, and other sizes that can be printed using a desktop printer and/or copier.

4. The apparatus of claim 1, wherein the pad sheet further includes a microperforation line and a perforation line, wherein the at least one anchor strip is between the microperforation line and the perforation line.

5. The apparatus of claim 1, wherein:
a) the at least one coupon includes two or more coupons;
b) each of the two or more coupons is coupled to another of the two or more coupons; and
c) each of the two or more coupons is coupled to the at least one anchor strip.

6. The apparatus of claim 5, wherein the pad sheet further includes a line of separation between each of the two or more coupons.

7. The apparatus of claim 1, wherein:
a) the pad sheet includes at least one row of coupons; and
b) the row of coupons includes the at least one coupon and the at least one anchor strip.

8. The apparatus of claim 1, wherein the pad sheet further includes an adhesive that is coupled to the anchor strip.

9. The apparatus of claim 8, wherein the adhesive is selected from the group consisting of a removable adhesive, a permanent adhesive, a repositionable adhesive, and an ultraremovable adhesive.

10. The apparatus of claim 8, wherein:
a) the pad sheet further includes a liner that is coupled to the adhesive; and
b) the adhesive is coupled between the anchor strip and the liner.

11. The apparatus of claim 1, wherein the pad sheet is configured to be fed through a desktop printer.

12. The apparatus of claim 1 further comprising a flyer sheet, wherein the pad sheet is configured to be coupled to the flyer sheet.

13. The apparatus of claim 12, wherein the flyer sheet is made of a material selected from the group consisting of cardstock sheet, printable papers, printable films, non-woven materials, polyolefin materials, and laminates thereof.

14. The apparatus of claim 12, wherein the flyer sheet has a size selected from the group consisting of A3, A4, 8½ inches by 11 inches, 8½ inches by 14 inches, 11 inches by 17 inches, and other sizes that can be printed using a desktop printer and/or copier.

15. The apparatus of claim 12, wherein the flyer sheet is configured to be fed through a printer.

16. A method of manufacturing a pad sheet, the method comprising:
a) providing a base sheet material;
b) forming at least one perforation line in the base sheet material;
c) forming at least one microperforation line in the base sheet material parallel to the at least one perforation line; and
d) attaching an adhesive strip to the base sheet material between the at least one perforation line and the at least one microperforation line.

17. The method of manufacturing the pad sheet of claim 16, wherein:
a) the step of forming the at least one perforation line includes forming more than one perforation line; and
b) the step of forming the at least one microperforation line includes forming more than one microperforation line.

18. A method of assembling a flyer assembly, the method including:
a) providing a pad sheet that includes rows of coupons;
b) separating a first row of coupons from a remaining portion of the pad sheet;
c) providing a flyer sheet; and
d) coupling the first row of coupons to the flyer sheet.

19. The method of assembling the flyer assembly of claim 18, wherein:
a) the first row of coupons includes an anchor strip; and
b) the step of coupling the first row of coupons to the flyer sheet includes coupling the anchor strip to the flyer sheet.

20. The method of assembling the flyer assembly of claim 18, further including:
a) separating a second row of coupons from the remaining portion of the pad sheet; and
b) coupling the second row of coupons to the first row of coupons.

21. The method of assembling the flyer assembly of claim 20, wherein:
a) the second row of coupons includes an anchor strip; and
b) the step of coupling the second row of coupons to the first row of coupons includes coupling the anchor strip of the second row to the anchor strip of the first row.
